(19) United States
(12) Patent Application Publication
(10) Pub. No.: US 2015/0123895 A1
(43) Pub. Date: May 7, 2015

(54) IMAGE DISPLAY SYSTEM, METHOD OF CONTROLLING IMAGE DISPLAY SYSTEM, AND HEAD-MOUNT TYPE DISPLAY DEVICE

(71) Applicant: SEIKO EPSON CORPORATION, Tokyo (JP)

(72) Inventor: Masahide TAKANO, Matsumoto-shi (JP)

(21) Appl. No.: 14/518,384

(22) Filed: Oct. 20, 2014

(30) Foreign Application Priority Data
Nov. 5, 2013 (JP) 2013-229441

(51) Int. Cl. G06F 3/01; G02B 27/01; G06F 3/03

(52) U.S. Cl. CPC G06F 3/017; G06F 3/0304; G02B 27/0179; G02B 27/017; G02B 2027/0187
USPC 345/156

(57) ABSTRACT

An image display system includes a head-mount type display device, and an input device adapted to operate the head-mount type display device, the input device includes a motion detection section adapted to detect a motion of a finger of a user, and the head-mount type display device includes an operation control section adapted to make the user visually recognize a virtual operation section as a virtual image, the virtual operation section being used for operating the head-mount type display device, and corresponding to the motion of the finger detected.

### BACKGROUND

1. Technical Field

The invention relates to an image display system provided with a head-mount type display device and an input device.

2. Related Art

There has been known a head-mount type display device (a head-mounted display (HMD)) as a display device to be mounted on the head. The head-mount type display device generates image light representing an image using, for example, a liquid crystal display and a light source, and then guides the image light thus generated to the eyes of the user using a projection optical system, a light guide plate, and so on to thereby make the user recognize a virtual image.

In JP-A-2000-284886 (Document 1) and JP-A-2000-029619 (Document 2), there is described a technology of detecting motions of respective fingers of the user using dedicated devices mounted on the respective fingers of the user, and using the motions of the fingers thus detected as an input to the head-mount type display device. In JP-A-2008-017501 (Document 3) and JP-A-2002-259046 (Document 4), there is described a system adapted to recognize motions of the fingers of the user using a camera installed in the head-mount type display device. In JP-A-2008-027453 (Document 5) and JP-A-2010-515978 (Document 6), there is described a technology of making it possible to simultaneously input an execution instruction and an operation amount related to rotation, expansion, contraction, and scrolling of an image using a motion history of a finger having contact with a touch panel.

In the technology described in Document 1, since character codes and symbol codes are assigned to the respective fingers of the user, there is a problem that the operation is difficult to understand. Similarly, in the technology described in Document 2, since commands such as a click and a drag are assigned to the motions (specifically, gestures such as lifting an index finger and then putting it back to the same position) of the user, there is a problem that the operation is difficult to understand. In the technology described in Document 3, camera operations such as a designation of a frame or release of a shutter can only be made possible, and there is a problem that it is not possible to provide such a sophisticated user interface (UI) as is widely used in current smartphones or the like. Similarly, in the technology described in Document 4, handwritten characters can only be recognized, and there is a problem that it is not possible to provide the sophisticated user interface. In the technologies described in Documents 5 and 6, there is a problem that no consideration is given to a head-mount type display device.

Therefore, in the technology of operating the head-mount type display device with motions of the fingers of the user such as an image display system provided with a head-mount type display device and an input device, there has been demanded an easy-to-understand and sophisticated user interface. Besides the above, in the image display system, there have been a variety of demands such as an improvement in usability, an improvement in general versatility, an improvement in convenience, an improvement in reliability, and reduction in manufacturing cost.

### SUMMARY

An advantage of the invention is to solve at least a part of the problems described above, and the invention can be implemented as the following aspects.

(1) An aspect of the invention provides an image display system including a transmissive head-mount type display device and an input device adapted to operate the head-mount type display device. In this image display system, the input device includes a motion detection section adapted to detect a motion of at least one finger of a user, and the head-mount type display device includes an operation control section adapted to make the user visually recognize a virtual operation section as a virtual image, the virtual operation section being used for operating the head-mount type display device, and corresponding to the motion of the finger detected. According to the image display system of this aspect of the invention, the operation control section makes the user visually recognize the virtual operation section corresponding to the motion of the finger of the user detected by the input device as the virtual image. Therefore, in the image display system provided with the head-mount type display device and the input device for operating the head-mount type display device, a user interface easy to understand and as sophisticated as GUI (graphical user interface) can be provided.

(2) The image display system according to the aspect of the invention described above may be configured such that the input device further includes an input surface adapted to detect information of a position touched by the user, and the operation control section makes the user visually recognize the virtual image of the virtual operation section larger than the input surface. According to the image display system of this aspect of the invention, the operation control section makes the user visually recognize the virtual image of the virtual operation section larger than the input surface provided to the input device. Since the user can perform the input using the large screen (the virtual operation section) compared to the case of performing the direct input using the input surface provided to the input device, usability for the user can be improved.

(3) The image display system according to the aspect of the invention described above may be configured such that the operation control section makes the user visually recognize the virtual image of the virtual operation section only in a case in which at least a part of the virtual image of the virtual operation section can be superimposed on the input surface. According to the image display system of this aspect of the invention, the operation control section makes the user visually recognize the virtual image of the virtual operation section only in the case in which at least a part of the virtual image of the virtual operation section can be superimposed on the input surface. The case in which at least a part of the virtual image of the virtual operation section can be superimposed on the input surface denotes, in other words, the case in which the eyes of the user wearing the head-mount type display device and the input surface of the input device are roughly collinear with each other. Therefore, according to such a process, it is possible to make the user visually recognize the virtual image of the virtual operation section only in the case in which the user wearing the head-mount type display device looks at the input surface of the input device.

(4) The image display system according to the aspect of the invention described above may be configured such that in a case in which at least a part of the virtual image of the virtual operation section is superimposed on the input surface, the operation control section makes the user visually recognize the virtual image of the virtual operation section in which the part superimposed is enlarged. According to the image display system of this aspect of the invention, in the case in which at least a part of the virtual image of the virtual operation section is superimposed on the input surface, the operation control section makes the user visually recognize the virtual image of the virtual operation section in which the part superimposed is enlarged. Therefore, it becomes possible for the user to use the input surface of the input device as a magnifying glass of the virtual operation section.

(5) The image display system according to the aspect of the invention described above may be configured such that the motion detection section detects a distance between the input surface and the finger of the user as a part of the motion of the finger, and the operation control section makes the user visually recognize the virtual image of the virtual operation section using a fact that the distance detected becomes one of equal to and smaller than a first threshold value as a trigger. According to the image display system of this aspect of the invention, the operation control section makes the user visually recognize the virtual image of the virtual operation section using the fact that the distance between the input surface and the finger of the user becomes equal to or smaller than the first threshold value as a trigger. As a result, it is possible for the user to start the display of the virtual operation section using such an intuitive operation as to move the finger close to the input surface of the input device.

(6) The image display system according to the aspect of the invention described above may be configured such that the head-mount type display device further includes an image display section adapted to form the virtual image, and the operation control section converts the motion of the finger detected into coordinate variation of a pointer on the virtual operation section to thereby generate a virtual operation section corresponding to the motion of the finger detected, and makes the image display section form a virtual image representing the virtual operation section generated. According to the image display system of this aspect of the invention, the operation control section can generate the virtual operation section corresponding to the motion of the finger thus detected by converting the motion of the finger of the user detected by the input device into the coordinate variation of the pointer on the virtual operation section. Further, the operation control section can make the user visually recognize the virtual image representing the virtual operation section thus generated using the image display section for forming the virtual image.

(7) The image display system according to the aspect of the invention described above may be configured such that the motion detection section detects a distance between the input surface and the finger of the user as a part of the motion of the finger, and the operation control section stops the conversion using a fact that the distance detected becomes one of equal to and smaller than a second threshold value as a trigger, and sets a coordinate of the pointer on which the conversion is performed last time to an input to the head-mount type display device using a fact that the distance detected becomes one of equal to and smaller than a third threshold value smaller than the second threshold value as a trigger. According to the image display system of this aspect of the invention, the operation control section stops the conversion of the motion of the finger detected into the coordinate of the pointer on the virtual operation section in the case in which the distance between the input surface and the finger of the user becomes equal to or smaller than the second threshold value. Therefore, it is possible for the operation control section to stop the coordinate variation of the pointer on the virtual operation section following the motion of the finger in the case in which the user moves the finger close to the input surface of the input device to some extent. Further, in the case in which the distance between the input surface and the finger of the user becomes equal to or smaller than the third threshold value smaller than the second threshold value, the operation control section sets the coordinate of the pointer, on which the conversion is performed last time, to the input to the head-mount type display device. Therefore, it is possible for the operation control section to determine the coordinate of the pointer at the second threshold value as the input to the head-mount type display device in the case in which the user further moves the finger closer to the input surface of the input device. According to such a process, in the image display system, occurrence of input blur due to hands movement of the user can be suppressed.

(8) The image display system according to the aspect of the invention described above may be configured such that the input device is configured as a wearable device, which can be worn by the user. According to the image display system of this aspect of the invention, since the input device is configured as a wearable device, which the user can wear, it is easy for the user to carry the head-mount type display device and the input device, and to use the devices any time.

All of the constituents provided to each of the aspects of the invention described above are not necessarily essential, and in order to solve all or a part of the problems described above, or in order to achieve all or a part of the advantages described in the specification, it is possible to arbitrarily make modification, elimination, replacement with a new constituent, partial deletion of restriction content on some of the constituents. Further, in order to solve all or a part of the problems described above, or in order to achieve all or a part of the advantages described in the specification, it is also possible to combine some or all of the technical features included in one of the aspects of the invention with some or all of the technical features included in another of the aspects of the invention to thereby form an independent aspect of the invention.

For example, an aspect of the invention can be implemented as a system provided with a part or all of the two elements, namely the motion detection section and the operation control section. In other words, it is also possible for the motion detection section to be included or not to be included in the device. Further, it is also possible for the operation control section to be included or not to be included in the device. Such a device can be implemented as, for example, an image display system, but can also be implemented as other devices than the image display system. Some or all of the technical features of the image display system described above as each of the aspects of the invention can be applied to this system.

It should be noted that the invention can be implemented as various aspects, such as a image display system using a head-mount type display device, a method of controlling the image display system, a head-mount type display device, a method of controlling a head-mount type display device, a computer program for implementing the functions of the methods, the devices, or the system, or a recording medium or the like recording the computer program.

### BRIEF DESCRIPTION OF THE DRAWINGS

The invention will be described with reference to the accompanying drawings, wherein like numbers reference like elements.

FIG. 1 is an explanatory diagram showing a schematic configuration of an image display system 1000 according to a first embodiment of the invention.

FIG. 2 is a block diagram functionally showing a configuration of an input device 300.

FIG. 3 is an explanatory diagram for explaining a motion detection section 320.

FIG. 4 is a block diagram functionally showing a configuration of a head-mounted display 100.

FIG. 5 is an explanatory diagram for explaining a virtual operation section.

FIG. 6 is an explanatory diagram showing an example of a virtual image to be visually recognized by the user.

FIG. 7 is a flowchart showing a procedure of an input process.

FIG. 8 is a flowchart showing the procedure of the input process.

FIGS. 9A and 9B are explanatory diagrams each showing an example of the virtual operation section displayed in the input process.

FIGS. 10A through 10C are explanatory diagrams related to a relationship between a change in a motion of a finger of the user and a change in the virtual operation section in the input process.

FIGS. 11A and 11B are explanatory diagrams related to the relationship between the change in the motion of the finger of the user and the change in the virtual operation section in the input process.

FIG. 12 is an explanatory diagram for explaining a first variation of the input process.

FIG. 13 is an explanatory diagram for explaining the first variation of the input process.

FIGS. 14A and 14B are explanatory diagrams for explaining a second variation of the input process.

FIG. 15 is an explanatory diagram for explaining a third variation of the input process.

FIGS. 16A and 16B are explanatory diagrams each showing a configuration of an appearance of a head-mounted display according to a modified example.

### DESCRIPTION OF AN EXEMPLARY EMBODIMENT

### A. Embodiment

### A-1. Configuration of Image Display System

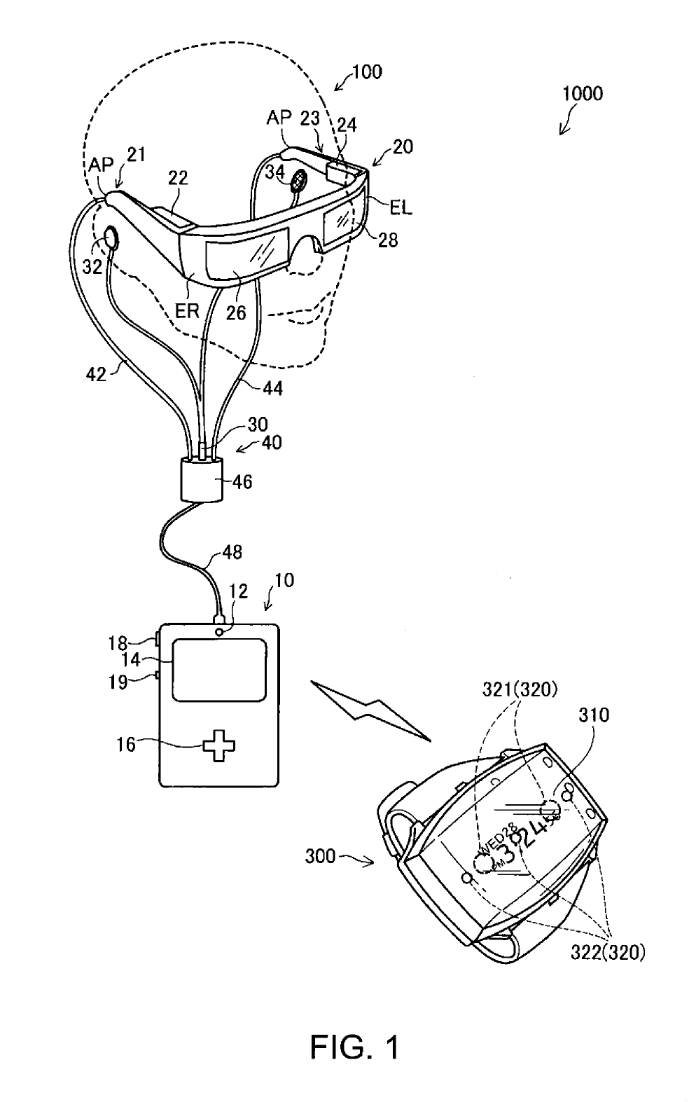

FIG. 1 is an explanatory diagram showing a schematic configuration of an image display system 1000 according to a first embodiment of the invention. The image display system 1000 is provided with a head-mount type display device 100 and an input device 300 as an external device. The input device 300 is a device for operating the head-mount type display device 100. The input device 300 performs an input process described later to make the operation of the head-mount type display device 100 by the user possible in cooperation with the head-mount type display device 100.

The head-mount type display device 100 is a display device to be mounted on the head, and is also called a head-mounted display (HMD). The head-mounted display 100 according to the present embodiment is an optical transmissive head-mount type display device allowing the user to visually recognize a virtual image and at the same time visually recognize an external sight directly. The input device 300 is an information communication terminal, and is configured as a wearable device, which can be worn by the user. In the present embodiment, a watch type device is described as an example. The head-mounted display 100 and the input device 300 are connected to each other so as to be able to communicate with each other wirelessly or in a wired manner.

### A-2. Configuration of Input Device

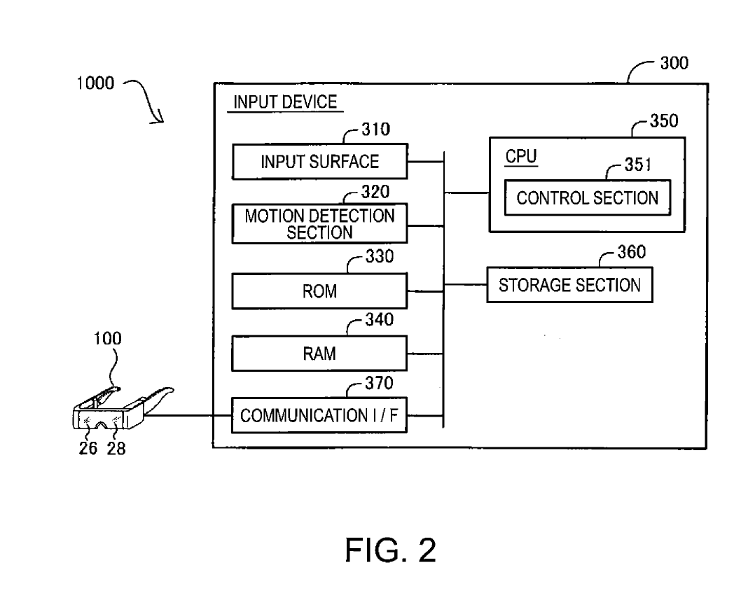

FIG. 2 is a block diagram functionally showing a configuration of the input device 300. As shown in FIGS. 1 and 2, the input device 300 is provided with an input surface 310, a motion detection section 320, a ROM 330, a RAM 340, a storage section 360, and a CPU 350.

The input surface 310 is a touch panel obtained by combining a display device such as a liquid crystal panel and a position input device such as a touch pad with each other, and detects information of a position at which the user has contact with the touch panel. The input surface 310 is disposed through out the entire surface of an upper part of a case of the input device 300.

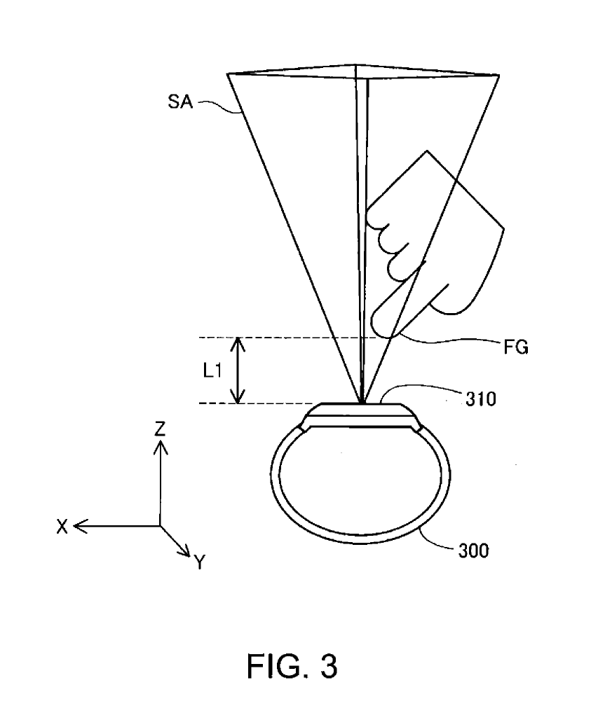

FIG. 3 is an explanatory diagram for explaining a motion detection section 320. As shown in FIG. 1, the motion detection section 320 is formed of a plurality of cameras 321 and a plurality of infrared light emitting diodes (LEDs) 322, and detects the motion of the finger of the user. Here, the “motion of the finger” denotes a three-dimensional motion of a finger FG expressed by an x direction, a y direction, and a z direction (FIG. 3). In order to detect the motion of the finger FG, the motion detection section 320 projects light beams emitted from the plurality of infrared LEDs 322 to the finger of the user, and shoots the reflected light beams using the plurality of cameras 321. It should be noted that a range in which the motion detection section 320 can detect the motion of the finger FG is called a detectable area SA. Further, in the present embodiment, the motion detection section 320 is provided with the two cameras and the three infrared LEDs. The motion detection section 320 is incorporated in the input device 300.

The CPU 350 retrieves and then executes a computer program stored in the storage section 360 to thereby function as a control section 351. The control section 351 cooperates with an operation control section 142 of the head-mounted display 100 to thereby perform the input process described later. Further, the control section 351 implements the functions listed as a1 and a2 below.

(a1) The control section 351 performs pairing with the head-mounted display 100. The control section 351 stores the information of the head-mounted display 100, with which the pairing is performed, in the storage section 360, and thereafter, blocks execution of the function a2 with other head-mounted display 100 and execution of the input process.

(a2) the control section 351 displays status of the head-mounted display 100, with which the pairing is performed, on the input surface 310. The status denotes, for example, presence or absence of incoming of a mail, presence or absence of incoming of a call, a remaining battery level, and a state of an application program executed in the head-mounted display 100.

The storage section 360 is constituted by a ROM, a RAM, a DRAM, a hard disk, and so on.

### A-3. Configuration of Head-Mount Type Display Device

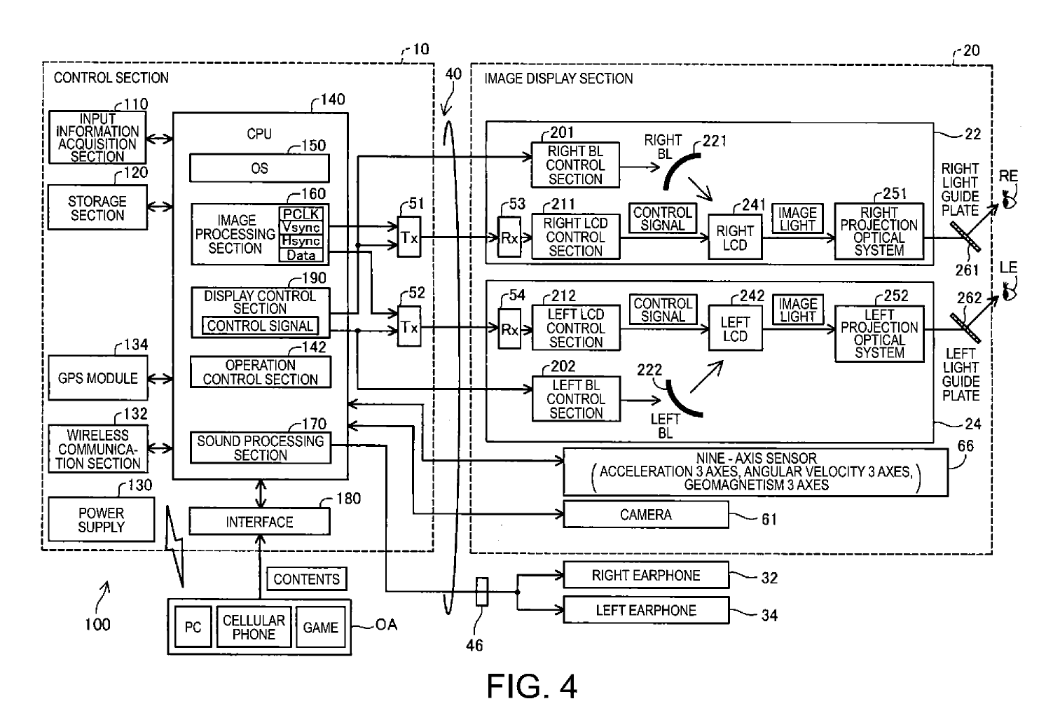

FIG. 4 is a block diagram functionally showing a configuration of the head-mounted display 100. As shown in FIG. 1, the head-mounted display 100 is provided with an image display section 20 for making the user visually recognize a virtual image in the state of being mounted on the head of the user, and a control section (a controller) 10 for controlling the image display section 20. The image display section 20 and the control section 10 are connected to each other by a connection section 40, and perform transmission of a variety of types of signals via the connection section 40. As the connection section 40, a metal cable and an optical fiber can be adopted.

### A-3-1. Configuration of Control Section

The control section 10 is a device for controlling the head-mounted display 100, and communicating with the input device 300. The control section 10 is provided with an input information acquisition section 110, a storage section 120, a power supply 130, a wireless communication section 132, a GPS module 134, a CPU 140, an interface 180, and transmitting sections (Tx) 51 and 52, and these components are connected to each other via a bus not shown.

The input information acquisition section 110 obtains a signal corresponding to an operation input to an input device such as a touch pad, an arrow key, a foot switch (a switch operated with a feet of the user), gesture detection (for detecting a gesture of the user using a camera or the like, and obtaining an operation input using a command linked with the gesture), visual line detection (for detecting a visual line of the user using an infrared sensor or the like, and obtaining the operation input using a command linked with the motion of the visual line), or a microphone. It should be noted that when performing the gesture detection, it is also possible to use a ring worn by the finger of the user, a tool held by a user with a hand, or the like as a mark for the motion detection. If it is arranged that the operation input using the foot switch, the visual line detection, or the microphone is obtained, convenience of the user in the case in which the head-mounted display 100 is used in a field site (e.g., a medical field, and a field site requiring an operation by hand such as the construction industry, or the manufacturing industry) difficult for the user to operate with a hand can dramatically be improved.

The storage section 120 is constituted by a ROM, a RAM, a DRAM, a hard disk, and so on. The power supply 130 supplies each section of the head-mounted display 100 with electrical power. As the power supply 130, a secondary cell, for example, can be used. The wireless communication section 132 performs wireless communication with an external device in compliance with a predetermined wireless communication standard (e.g., Near Field Communication such as an infrared ray or Bluetooth (a registered trademark), or a wireless LAN such as IEEE 802.11). The external device denotes other equipment than the head-mounted display 100, and there can be cited a tablet terminal, a personal computer, a game terminal, an audio-video (AV) terminal, a home electric appliance, and iso on besides the input device 300 shown in FIG. 1. The GPS nodule 134 receives a signal from a GPS satellite to thereby detect the current location of the user of the head-mounted display 100, and generates current location information representing the current location of the user. It should be noted that the current location information can be implemented by, for example, a coordinate representing latitude/longitude.

The CPU 140 retrieves and then executes the computer programs stored in the storage section 120 to thereby function as an operation control section 142, an operating system (OS) 150, an image processing section 160, a sound processing section 170, and a display control section 190.

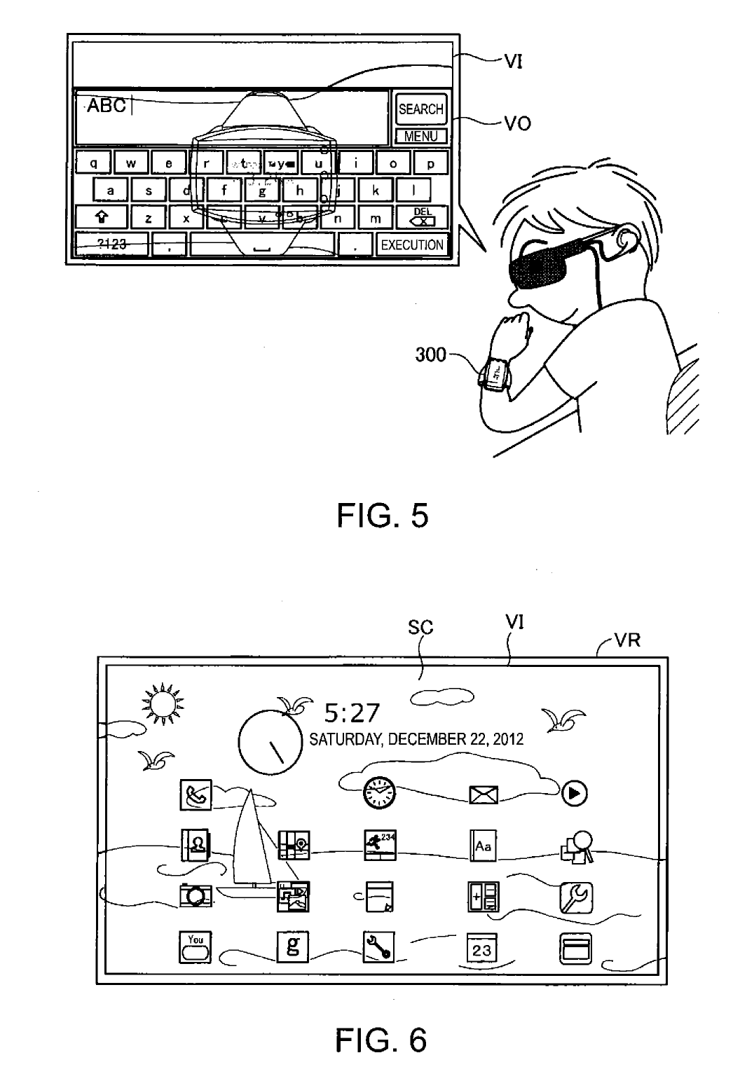

FIG. 5 is an explanatory diagram for explaining a virtual operation section. The operation control section 142 (FIG. 4) performs the input operation in cooperation with the input device 300. In the input process, the operation control section 142 makes the user visually recognize the virtual operation section VO for the user to operate the head-mounted display 100. As shown in the drawing, in the present embodiment, a virtual image VI of the virtual operation section VO to be visually recognized by the user is larger than the input surface 310 of the input device 300. Further, as shown in the drawing, in the present embodiment, the virtual image VI of the virtual operation section VO is displayed only in the case in which at least a part of the virtual image VI can be superimposed on the input surface 310, in other words, only in the case in which the eyes of the user wearing the head-mounted display 100 and the input surface 310 of the input device 300 are roughly collinear with each other.

The image processing section 160 generates a signal based on a video signal input from the operation control section 142, the interface 180, the wireless communication section 132, and so on via the OS 150. The image processing section 160 supplies the image display section 20 with the signal thus generated via the connection section 40 to thereby control the display in the image display section 20. The signal to be supplied to the image display section 20 is different between an analog system and a digital system.

For example, in the case of the digital system, the video signal in the state in which a digital R signal, a digital G signal, and a digital B signal, and a clock signal PCLK are synchronized with each other is input. The image processing section 160 performs image processing such as a resolution conversion process, a variety of color correction process such as an adjustment of the luminance/chromaticness, or a keystone distortion correction process all known to the public on the image data Data formed of the digital R signal, the digital G signal, and the digital B signal if necessary. Thereafter, the image processing section 160 transmits the clock signal PCLK and the image data Data via the transmitting sections 51, 52.

In the case of the analog system, the video signal formed of an analog RGB signal, a vertical sync signal VSync, and a horizontal sync signal HSync is input. The image processing section 160 separates the vertical sync signal VSync and the horizontal sync signal HSync from the signal thus input, and generates the clock signal PCLK in accordance with the periods of these signals. Further, the image processing section 160 converts the analog RGB signals into the digital signal using an A/D conversion circuit or the like. The image processing section 160 performs the known image processing on the image data Data formed of the digital RGB signals thus converted if necessary, and then transmits the clock signal PCLK, the image data Data, the vertical sync signal VSync, and the horizontal sync signal HSync via the transmitting sections 51, 52. It should be noted that hereinafter the image data Data transmitted via the transmitting section 51 is also referred to as “right eye image data Data 1,” and the image data Data transmitted via the transmitting section 52 is also referred to as “left eye image data Data 2.”

The display control section 190 generates control signals for controlling a right display drive section 22 and the left display drive section 24 provided to the image display section 20. The control signals are signals for individually switching ON/OFF the drive of a right LCD 241 by a right LCD control section 211, switching ON/OFF the drive of a right backlight 221 by a right backlight control section 201, switching ON/OFF the drive of a left LCD 242 by a left LCD control section 212, and switching ON/OFF the drive of a left backlight 222 by a left backlight control section 202. The display control section 190 controls generation and emission of the image light in each of the right display drive section 22 and the left display drive section 24 using these control signals. The display control section 190 transmits the control signals thus generated via the transmitting sections 51, 52.

The sound processing section 170 obtains a sound signal included in the content, amplifies the sound signal thus obtained, and then supplies the result to a speaker not shown of the right earphone 32 and a speaker not shown of the left earphone 34.

The interface 180 performs wired communication with the external device in compliance with predetermined wired communication standards (e.g., micro USB (universal serial bus), USB, HDMI (high definition multimedia interface), VGA (video graphics array), composite (RCA), RS-232C (recommended standard 232 version C), and a wired LAN standard such as IEEE 802.3). The external device denotes other equipment than the head-mounted display 100, and there can be cited a tablet terminal, a personal computer, a game terminal, an AV terminal, a home electric appliance, and so on besides the input device 300 shown in FIG. 1.

### A-3-2. Configuration of Image Display Section

The image display section 20 is a mounting body to be mounted on the head of the user, and has a shape of a pair of glasses in the present embodiment. The image display section 20 includes the right display drive section 22, the left display drive section 24, a right optical image display section 26 (FIG. 1), a left optical image display section 28 (FIG. 1), and a nine-axis sensor 66.

The right display drive section 22 and the left display drive section 24 are disposed at positions opposed to the temples of the user when the user wears the image display section 20. The right display drive section 22 and the left display drive section 24 in the present embodiment each generate and then emit image light representing an image using a liquid crystal display (hereinafter referred to as an “LCD”) and a projection optical system.

The right display drive section 22 includes a receiving section (Rx) 53, the right backlight (BL) control section 201 and the right backlight (BL) 221 functioning as a light source, the right LCD control section 211 and the right LCD 241 functioning as a display element, and a right projection optical system 251.

The receiving section 53 receives the data transmitted from the transmitting section 51. The right backlight control section 201 drives the right backlight 221 based on the control signal input to the right backlight control section 201. The right backlight 221 is a light emitter such as, for example, an LED or electroluminescence (EL). The right LCD control section 211 drives the right LCD 241 based on the clock signal PCLK, the right-eye image data Data1, the vertical sync signal VSync, and the horizontal sync signal HSync input to the right LCD control section 211. The right LCD 241 is a transmissive liquid crystal panel having a plurality of pixels arranged in a matrix. The right LCD 241 varies the transmittance of the light transmitted through the right LCD 241 by driving the liquid crystal corresponding to each of the pixel positions arranged in a matrix to thereby modulate the illumination light, which is emitted from the right backlight 221, into valid image light representing the image. The right projection optical system 251 is formed of a collimating lens for converting the image light emitted from the right LCD 241 into a light beam in a parallel state.

The left display drive section 24 has roughly the same configuration as that of the right display drive section 22, and operates similarly to the right display drive section 22. Specifically, the left display drive section 24 includes a receiving section (Rx) 54, the left backlight (BL) control section 202 and the left backlight (BL) 222 functioning as a light source, the left LCD control section 212 and the left LCD 242 functioning as a display element, and a left projection optical system 252. The detailed explanation thereof will be omitted. It should be noted that although it is assumed in the present embodiment that the backlight system is adopted, it is also possible to emit the image light using a front light system or a reflecting system.

The right optical image display section 26 and the left optical image display section 28 are disposed so as to be located in front of the right and left eyes of the user, respectively, when the user wears the image display section 20 (see FIG. 1). The right optical image display section 26 includes a right light guide plate 261 and a dimming plate not shown. The right light guide plate 261 is formed of a light transmissive resin material or the like. The right light guide plate 261 guides the image light, which is output from the right display drive section 22, to a right eye RE of the user while reflecting the image light along a predetermined light path. As the right light guide plate, it is possible to use a diffraction grating, or a semi-transmissive reflecting film. The dimming plate is an optical element having a thin-plate shape, and is disposed so as to cover an obverse side of the image display section 20. The dimming plate protects the right light guide plate 261, and at the same time, controls an intensity of outside light entering the eyes of the user by controlling the light transmission rate to control easiness of the visual recognition of the virtual image. It should be noted that the dimming plate can be eliminated.

The left optical image display section 28 has roughly the same configuration as that of the right optical image display section 26, and operates similarly to the right optical image display section 26. Specifically, the left optical image display section 28 includes the left light guide plate 262 and a dimming plate not shown, and guides the image light output from the left display drive section 24 to a left eye LE of the user. The detailed explanation thereof will be omitted.

The nine-axis sensor 66 is a motion sensor for detecting accelerations (3 axes), angular velocities (3 axes), and geomagnetisms (3 axes). The nine-axis sensor 66 is provided to the image display section 20, and therefore functions as a head motion detection section for detecting a motion of the head of the user of the head-mounted display 100 when the image display section 20 is mounted on the head of the user. Here, the motion of the head includes the velocity, the acceleration, the angular velocity, the orientation, and a change in orientation of the head.

FIG. 6 is an explanatory diagram showing an example of a virtual image visually recognized by the user. In FIG. 6, a visual field VR of the user is shown as an example. By the image light guided to both eyes of the user of the head-mounted display 100 being imaged on the retina of the user in such a manner as described above, the user can visually recognize the virtual image VI. In the example shown in FIG. 6, the virtual image VI is a standby screen of OS of the head-mounted display 100. Further, the user visually recognizes an external sight SC through the right optical image display section 26 and the left optical image display section 28 in a see-through manner. As described above, the user of the head-mounted display 100 according to the present embodiment can see the virtual image VI and the external sight SC behind the virtual image VI with respect to a part of the visual field VR in which the virtual image VI is displayed. Further, the user can directly see the external sight SC through the right optical image display section 26 and the left optical image display section 28 in a see-through manner with respect to a part of the visual field VR in which the virtual image VI is not displayed. It should be noted that in the present specification, the operation of “the head-mounted display 100 displaying an image” includes an operation of making the user of the head-mounted display 100 visually recognize a virtual image.

### A-4. Arrangement Process

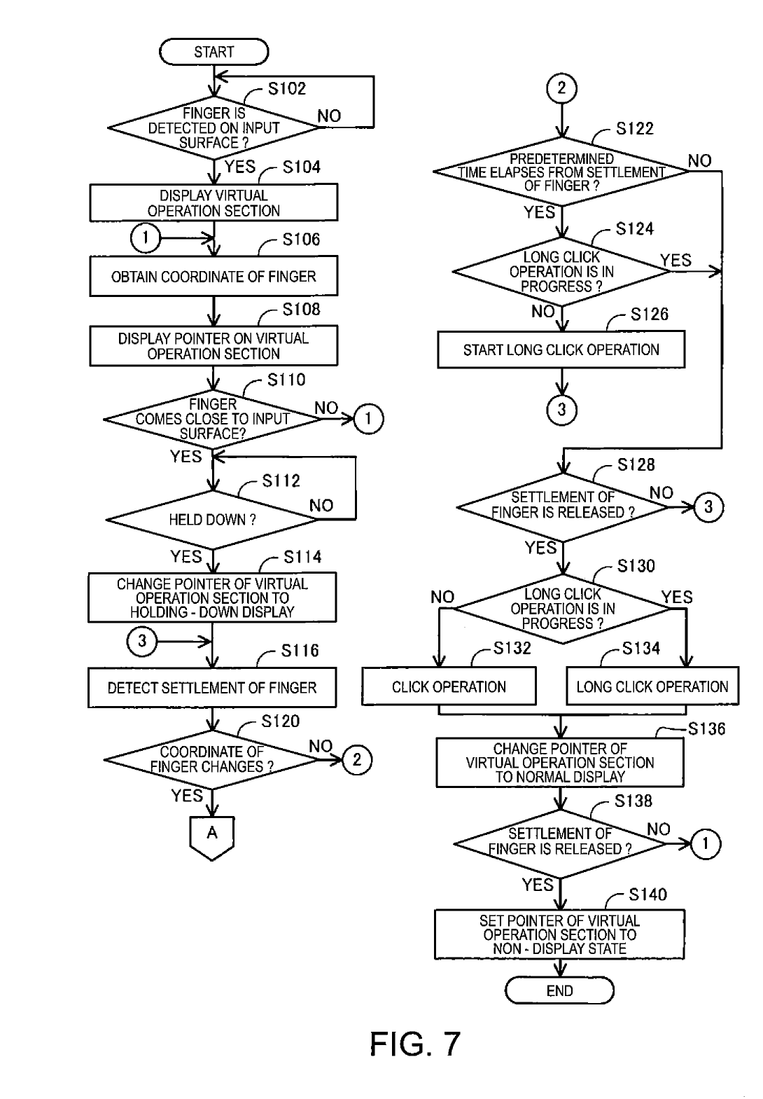

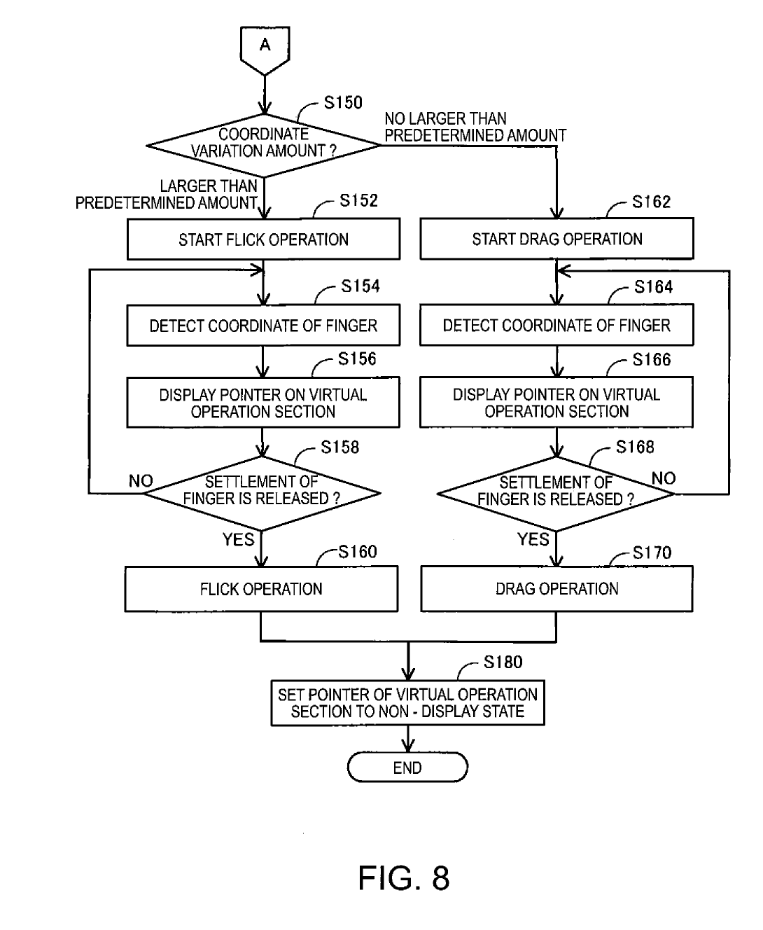

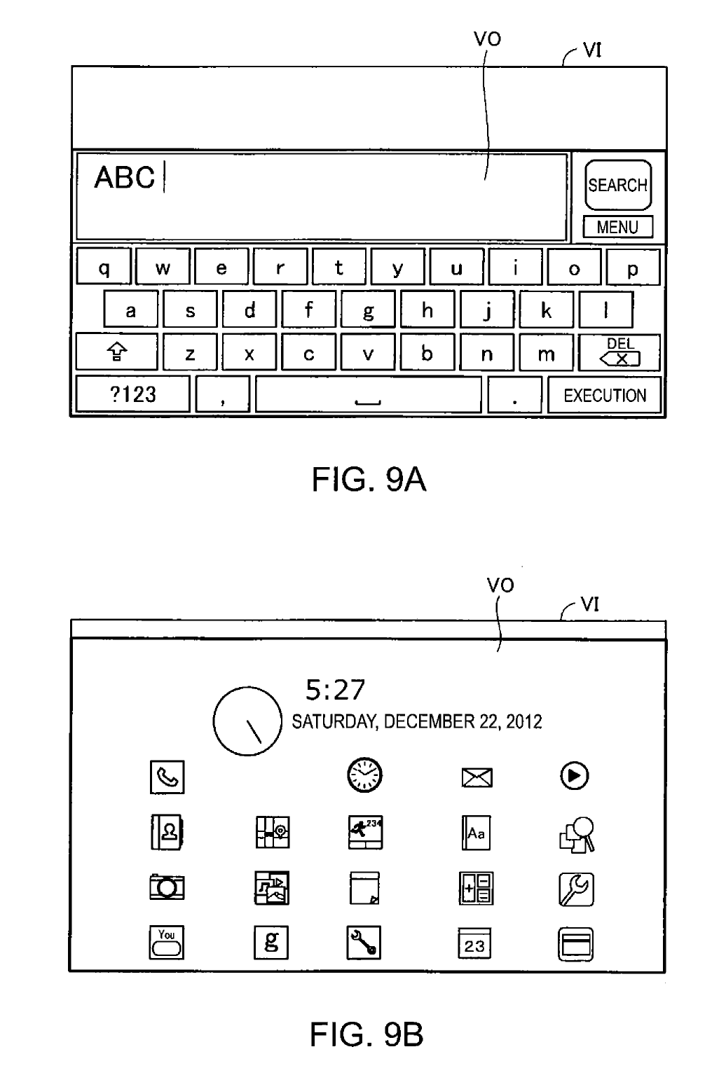

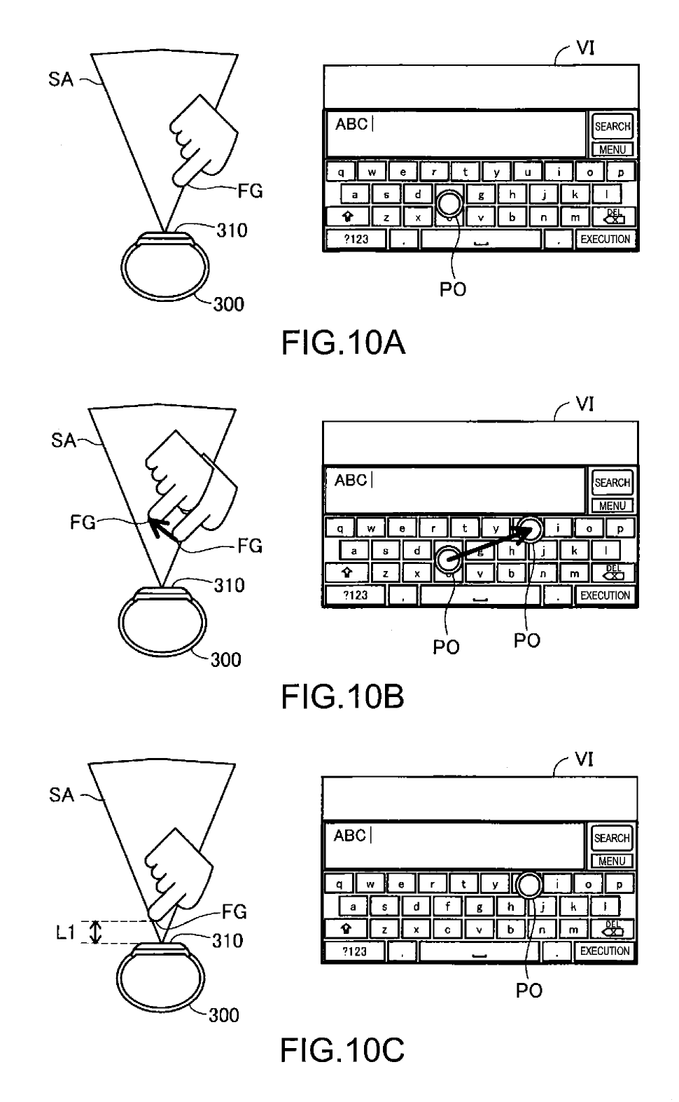

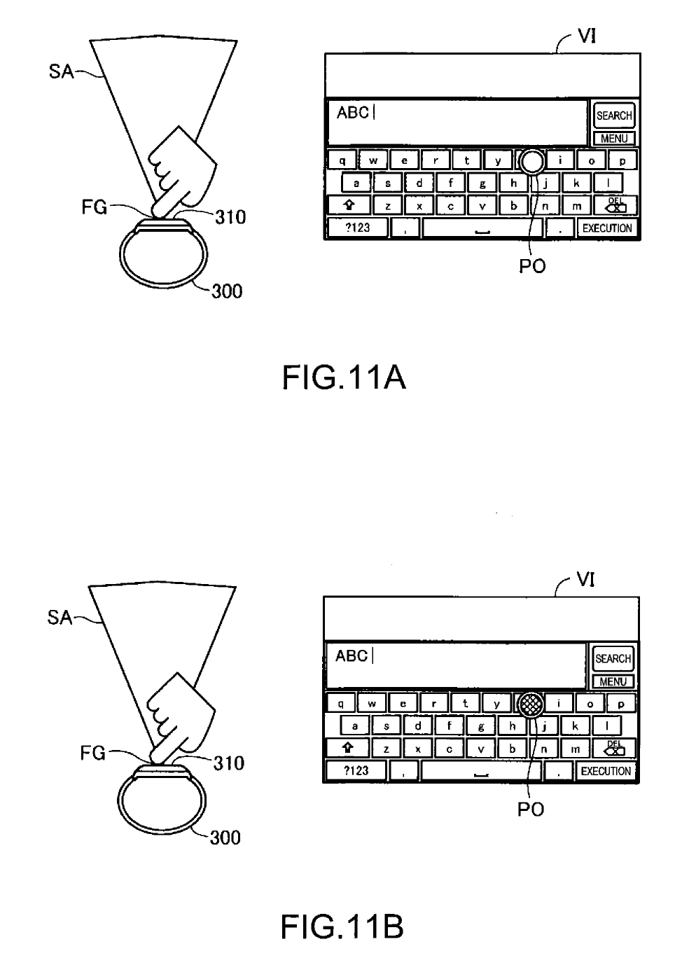

FIGS. 7 and 8 are flowcharts showing the procedure of the input process. FIGS. 9A and 9B are explanatory diagrams showing an example of the virtual operation section displayed in the input process. FIGS. 10A through 10C, 11A, and 11B are explanatory diagrams related to a relationship between a change in the motion of the finger of the user and a change in the virtual operation section in the input process. As shown in FIG. 5, the input process is a process for making the user visually recognize the virtual image VI representing the virtual operation section VO, and at the same time, obtaining the input from the user using the virtual operation section VO.

The input process is performed by the operation control section 142 of the head-mounted display 100 and the control section 351 of the input device 300 in cooperation with each other. An execution condition of the input process in the present embodiment is that the virtual image VI of the virtual operation section VO can be superimposed on the input surface 310 (i.e., the eyes of the user wearing the head-mounted display 100 and the input surface 310 of the input device 300 are roughly collinear with each other). The execution condition can be determined, in the case in which a light emitting section and a light receiving section of an infrared ray are provided respectively to the optical image display section of the head-mounted display 100 and the input surface 310 of the input device 300, based on whether or not the light receiving section can receive the infrared ray from the light emitting section. It should be noted that the determination of the execution condition can be performed by the operation control section 142, or can be performed by the control section 351. The operation control section 142 and the control section 351 perform the input process shown in FIGS. 7 and 8 only in the case in which the execution condition described above is satisfied.

In the step S102 of FIG. 7, the control section 351 determines whether or not the finger of the user is detected on the input surface 310. Specifically, the control section 351 obtains a distance L1 (FIG. 3) between the input surface 310 and the finger FG of the user based on the motion of the finger of the user detected by the motion detection section 320. In the case in which the distance L1 is equal to or smaller than a first threshold value, the control section 351 determines that the finger of the user is detected, and in the case in which the distance L1 is larger than the first threshold value, the control section 351 determines that the finger of the user is not detected. It should be noted that the first threshold value can arbitrarily be determined, and is set to, for example, 20 mm in the present embodiment. In the case in which the finger of the user is not detected (NO in the step S102), the process returns to the step S102, and the control section 351 repeats the determination on whether or not the finger is detected. In the case in which the finger of the user is detected (YES in the step S102), the control section 351 makes the process make the transition to the step S104.

In the step S104, the operation control section 142 displays the virtual operation section. Specifically, the operation control section 142 generates an image representing the virtual operation section VO having a keyboard shown in FIG. 9A arranged, or the virtual operation section VO the same as a desktop screen of the OS shown in FIG. 9B. It should be noted that it is possible for the operation control section 142 to obtain the virtual operation section VO from the outside (e.g., the OS 150) instead of generating the virtual operation section VO. Subsequently, the operation control section 142 transmits the image representing the virtual operation section VO thus generated or obtained to the image processing section 160. In the image processing section 160 having received the image representing the virtual operation section VO in the display process described above is performed. As a result, by the image light guided to both eyes of the user of the head-mounted display 100 being imaged on the retina of the user, the user can visually recognize the virtual image VI of the image representing the virtual operation section VO in the visual field. In other words, the head-mounted display 100 can display the virtual operation section VO.

In the step S106, the operation control section 142 obtains a coordinate of the finger. Specifically, the control section 351 obtains the motion of the finger of the user detected by the motion detection section 320, and then transmits the motion of the finger to the head-mounted display 100 via a communication interface 370. The operation control section 142 obtains the motion of the finger of the user received via the wireless communication section 132. The operation control section 142 converts the motion of the finger of the user thus obtained, namely the three-dimensional motion (FIG. 3) of the finger FG represented by the x direction, the y direction, and the z direction into a coordinate on the virtual operation section VO (FIGS. 9A and 9B).

In the step S108 in FIG. 7, the operation control section 142 displays a pointer (a pointing body) in the virtual operation section in accordance with the motion of the finger of the user. Specifically, the operation control section 142 superimposes the image representing the pointer on the position of the coordinate of the finger obtained in the step S106, and then transmits the image thus superimposed to the image processing section 160. FIG. 10A shows the virtual operation section VO displayed through the step S108. In FIG. 10A, a pointer PO is displayed at a position corresponding to the position of the finger FG of the user in the virtual operation section VO.

In the step S110 of FIG. 7, the operation control section 142 determines whether or not the finger of the user is close to the input surface 310. Specifically, the operation control section 142 obtains the distance L1 (FIG. 3) between the input surface 310 and the finger FG of the user based on the motion of the finger of the user obtained in the step S106. In the case in which the distance L1 is equal to or smaller than a second threshold value, the operation control section 142 determines that the finger of the user is close to the input surface 310, and in the case in which the distance L1 is larger than the second threshold value, the operation control section 142 determines that the finger of the user is not close to the input surface 310. It should be noted that the second threshold value can arbitrarily be determined, and is set to, for example, 10 mm in the present embodiment.

In the case in which the finger of the user is not close (NO in the step S110), the process returns to the step S106, and the operation control section 142 continues the detection of the motion of the finger of the user and the display of the virtual operation section on which the pointer is disposed in accordance with the motion. FIG. 10B shows the state of the virtual operation section VO in which the pointer PO corresponding to the motion of the finger FG of the user is displayed by repeating the steps S106 through S110 (with the determination of NO).

In the case in which the finger of the user is close (YES in the step S110), the operation control section 142 determines (step S112) whether or not the input surface 310 is held down. Specifically, the operation control section 142 determines that the input surface 310 is held down in the case in which the distance L1 (FIG. 10C) obtained based on the motion of the finger of the user obtained in the step S106 is equal to or smaller than a third threshold value, or determines that input surface is not held down in the case in which the distance L1 is larger than the third threshold value. It should be noted that the third threshold value can arbitrarily be determined, and is set to, for example, 0 mm (the state in which the finger of the user has contact with the input surface 310) in the present embodiment.

In the case in which the input surface 310 is not held down (NO in the step S112), the process returns to the step S112, and the operation control section 142 continues to monitor holding down of the input surface 310. It should be noted that when continuing to monitor holding down of the input surface 310, the operation control section 142 keeps the display of the virtual operation section when the distance L1 becomes equal to or smaller than the second threshold value, and does not perform the display of the virtual operation section corresponding to the motion of the finger of the user.

In the case in which the input surface 310 is held down (YES in the step S112), the operation control section 142 changes (step S114) the pointer of the virtual operation section to a holding-down display. Here, the holding-down display denotes a display configuration of the pointer, which is modified to an extent distinguishable from the normal pointer. In the holding-down display, at least either one of for example, the shape, the color, and the decoration of the pointer can be changed. FIG. 11A shows the state in which the input surface 310 is held down by the finger FG of the user. FIG. 11B shows the state in which the pointer PO of the virtual operation section VO is changed to the holding-down display due to the step S114.

In the step S116 in FIG. 7, the operation control section 142 detects settlement of the finger. Specifically, the operation control section 142 obtains the coordinate (in other words, the coordinate of the pointer on the virtual operation section) of the finger on which the conversion of the step S106 is performed last time as the coordinate position at which the “settlement of the finger” is performed. It should be noted that the coordinate at which the settlement of the finger is performed is hereinafter also referred to as a “settled coordinate of the finger.”

In the step S120, the operation control section 142 determines whether or not the coordinate of the finger has changed. Specifically, the operation control section 142 obtains the motion of the finger of the user detected by the motion detection section 320, performs a conversion similar to the step S106 to obtain the coordinate of the finger on the virtual operation section. The operation control section 142 compares this coordinate and the settled coordinate of the finger obtained in the step S116 with each other to determine whether or not a change has occurred. In the case in which the coordinate of the finger has not changed (NO in the step S120), the operation control section 142 makes the process make the transition to the step S122. In the case in which the coordinate of the finger has changed (YES in the step S120), the operation control section 142 makes the process make the transition to the step S150 in FIG. 8.

In the step S122, the operation control section 142 determines whether or not a predetermined time has elapsed from the settlement (step S116) of the finger. It should be noted that the predetermined time can arbitrarily be determined, and is set to, for example, 1 second in the present embodiment. In the case in which the predetermined time has not elapsed (NO in the step S122), the operation control section 142 makes the process make the transition to the step S128. In the case in which the predetermined time has elapsed (YES in the step S122), the operation control section 142 determines in the step S124 whether or not a long click operation is in progress. Whether or not the long click operation is in progress can be handled using, for example, a flag.

In the case in which the long click operation is in progress (YES in the step S124), the operation control section 142 makes the process make the transition to the step S128. In the case in which the long click operation is not in progress (NO in the step S124), the operation control section 142 starts the long click operation in the step S126. Specifically, the operation control section 142 makes the process make the transition to the step S116, and then counts the elapsed time from the first settlement (step S116) of the finger.

In the step S128, the operation control section 142 determines whether or not the settlement of the finger has been released. Specifically, the operation control section 142 obtains the motion of the finger of the user detected by the motion detection section 320, performs a conversion similar to the step S106 to obtain the coordinate of the finger on the virtual operation section. The operation control section 142 determines that the settlement of the finger has been released in the case in which there occurs at least either one of the case in which a changed has occurred in comparison between the present coordinate and the settled coordinate of the finger obtained in the step S116, and the case in which the distance L1 based on the motion of the finger of the user thus obtained has exceeded the third threshold value.

In the case in which the settlement of the finger has not been released (NO in the step S128), the operation control section 142 makes the process make the transition to the step S116, and then continues to count the elapsed time from the first settlement (step S116) of the finger. In the case in which the settlement of the finger has been released (YES in the step S128), the operation control section 142 determines whether or not a long click operation is in progress. The details are roughly the same as in the step S124.

In the case in which the long click operation is not in progress (NO in the step S130), the operation control section 142 determines (step S132) that a click operation (a tap operation) has been performed by the user. The operation control section 142 transmits the information representing that the click operation has occurred, and the settled coordinate of the finger obtained in the step S116 to the OS 150 and other application programs as an input to the head-mounted display 100. In the case in which the long click operation is in progress (YES in the step S130), the operation control section 142 determines (step S134) that the long click operation (a long tap operation) has been performed by the user. The operation control section 142 transmits the information representing that the long click operation has occurred, and the settled coordinate of the finger obtained in the step S116 to the OS 150 and other application programs as an input to the head-mounted display 100.

In the step S136, the operation control section 142 changes the pointer of the virtual operation section to the normal display. The details are roughly the same as in the step S114. In the step S138, the operation control section 142 determines whether or not the settlement of the finger has been released. The details are roughly the same as in the step S128. In the case in which the settlement of the finger has not been released (NO in the step S138), the operation control section 142 makes the process make the transition to the step S106, and repeats the process described above. In the case in which the settlement of the finger has been released (YES in the step S138), the operation control section 142 sets the pointer of the virtual operation section to a non-display state in the step S140, and then terminates the process.

As described above, according to the steps S102 through S140, the click operation and the long click operation can be obtained using the virtual operation section corresponding to the motion of the finger of the user. Then, acquisition of a flick operation and a drag operation will be explained using FIG. 8.

In the step S150 in FIG. 8, the operation control section 142 determines the variation amount in the coordinate of the finger in the step S120. In the case in which the variation amount in the coordinate of the finger is larger than a predetermined amount (LARGER THAN PREDETERMINED AMOUNT in the step S150), the operation control section 142 starts the flick operation in the step S152. It should be noted that the predetermined amount can arbitrarily be determined.

In the step S154, the operation control section 142 obtains the coordinate of the finger. The details are roughly the same as in the step S106 shown in FIG. 7. In the step S156, the operation control section 142 displays the pointer in the virtual operation section in accordance with the motion of the finger of the user. The details are roughly the same as in the step S108 shown in FIG. 7. The operation control section 142 repeatedly performs the steps S154, S156 in order to change the position of the pointer so as to follow the flick operation of the user. Then, the operation control section 142 changes the pointer of the virtual operation section to the holding-down display at the moment when the motion of the finger of the user stops. The details are roughly the same as in the step S114.

In the step S158, the operation control section 142 determines whether or not the settlement of the finger has been released. The details are roughly the same as in the step S128. In the case in which the settlement of the finger has not been released (NO in the step S158), the operation control section 142 makes the process make the transition to the step S154, and repeats the process described above. In the case in which the settlement of the finger has been released (YES in the step S158), the operation control section 142 determines (step S160) that the flick operation has been performed by the user. The operation control section 142 transmits the information representing that the flick operation has occurred, and the series of coordinates of the finger obtained in the step S154 to the OS 150 and other application programs as an input to the head-mounted display 100. Subsequently, the operation control section 142 makes the process make the transition to the step S180.

In the case in which the variation amount in the coordinate of the finger is equal to or smaller than the predetermined amount in the step S150 (NO LARGER THAN PREDETERMINED AMOUNT in the step S150), the operation control section 142 starts the drag operation in the step S162.

In the step S164, the operation control section 142 obtains the coordinate of the finger. The details are roughly the same as in the step S106 shown in FIG. 7. In the step S166, the operation control section 142 displays the pointer in the virtual operation section in accordance with the motion of the finger of the user. The details are roughly the same as in the step S108 shown in FIG. 7. The operation control section 142 repeatedly performs the steps S164, S166 in order to change the position of the pointer so as to follow the drag operation of the user. Then, the operation control section 142 changes the pointer of the virtual operation section to the holding-down display at the moment when the motion of the finger of the user stops. The details are roughly the same as in the step S114.

In the step S168, the operation control section 142 determines whether or not the settlement of the finger has been released. The details are roughly the same as in the step S128. In the case in which the settlement of the finger has not been released (NO in the step S168), the operation control section 142 makes the process make the transition to the step S164, and repeats the process described above. In the case in which the settlement of the finger has been released (YES in the step S168), the operation control section 142 determines (step S170) that the drag operation has been performed by the user. The operation control section 142 transmits the information representing that the drag operation has occurred, and the series of coordinates of the finger obtained in the step S164 to the OS 150 and other application programs as an input to the head-mounted display 100. Subsequently, the operation control section 142 makes the process make the transition to the step S180.

In the step S180, the operation control section 142 changes the pointer of the virtual operation section to the non-display state, and then terminates the process.

As described above, according to the first embodiment, the operation control section 142 makes the user visually recognize the virtual operation section (the virtual operation section VO) in accordance with the motion of the finger of the user detected by the motion detection section 320 of the input device 300 as the virtual image VI. Therefore, in the image display system 1000 provided with the head-mounted display 100 (the head-mount type display device) and the input device 300 for operating the head-mounted display 100, a user interface easy to understand and as sophisticated as GUI (graphical user interface) can be provided.

Further, according to the input process (FIGS. 7 and 8) of the first embodiment, by converting the motion of the finger of the user detected by the motion detection section 320 of the input device 300 into the coordinate variation of the pointer PO (the pointing body) on the virtual operation section VO, the operation control section 142 can generate the virtual operation section VO corresponding to the motion of the finger thus detected.

Further, as shown in FIG. 5, according to the input process (FIGS. 7 and 8) of the first embodiment, the operation control section 142 makes the user visually recognize the virtual image VI of the virtual operation section VO larger than the input surface 310 provided to the input device 300. Since the user can perform the input to the head-mounted display 100 (the head-mount type display device) using the large screen (the virtual operation section VO) compared to the case of performing the direct input using the input surface 310 provided to the input device 300, usability for the user can be improved.

Further, according to the input process (FIGS. 7 and 8) of the first embodiment, the operation control section 142 performs the input process only in the case in which at least a part of the virtual image VI of the virtual operation section VO can be superimposed on the input surface 310, and thus makes the user visually recognize the virtual image VI of the virtual operation section VO. The case in which at least a part of the virtual image VI of the virtual operation section VO can be superimposed on the input surface 310 denotes, in other words, the case in which the eyes of the user wearing the head-mounted display 100 (the head-mount type display device) and the input surface 310 of the input device 300 are roughly collinear with each other. Therefore, according to such a process, it is possible to make the user visually recognize the virtual image VI of the virtual operation section VO only in the case in which the user wearing the head-mounted display 100 looks at the input surface 310 of the input device 300.

Further, according to the input process (FIGS. 7 and 8) of the first embodiment, the operation control section 142 makes the user visually recognize (steps S102, S104) the virtual image VI of the virtual operation section VO using the fact that the distance L1 between the input surface 310 and the finger of the user becomes equal to or smaller than the first threshold value as a trigger. As a result, it is possible for the user to start the display of the virtual operation section VO using such an intuitive operation as to move the finger close to the input surface 310 of the input device 300.

Further, according to the input process (FIGS. 7 and 8) of the first embodiment, the operation control section 142 stops (steps S110, S112) converting the motion of the finger detected into the coordinate of the pointer PO (the pointing body) on the virtual operation section VO in the case in which the distance L1 between the input surface 310 and the finger of the user becomes equal to or smaller than the second threshold value. Therefore, it is possible for the operation control section 142 to stop the coordinate variation of the pointer PO on the virtual operation section VO following the motion of the finger in the case in which the user moves the finger close to the input surface 310 of the input device 300 to some extent. Further, in the case in which the distance L1 between the input surface 310 and the finger of the user becomes equal to or smaller than the third threshold value smaller than the second threshold value, the operation control section 142 sets the coordinate (in other words, the settled coordinate of the finger) of the pointer PO, on which the conversion is performed last time, as the input to the head-mounted display 100 (the head-mount type display device). Therefore, it is possible for the operation control section 142 to determine the coordinate of the pointer PO at the second threshold value as the input to the head-mounted display 100 in the case in which the user further moves the finger closer to the input surface 310 of the input device 300. According to such a process, in the image display system 1000, occurrence of input blur due to hands movement of the user can be suppressed.

Further, according to the first embodiment, since the input device 300 is configured as a wearable device, which the user can wear, it is easy for the user to carry the head-mounted display 100 (the head-mount type display device) and the input device 300, and to use the devices any time.

### A-5. Variations on Arrangement Process

Hereinafter, variations on the arrangement process explained using FIGS. 5, 7, 8, 9A, 9B, 10A through 10C, 11A, and 11B will be explained. Hereinafter, only the part having a configuration and an operation different from those of the arrangement process described above will be explained. It should be noted that in the drawings, the constituents substantially the same as those of the arrangement process described above are denoted with the same reference numerals as shown in FIGS. 5, 7, 8, 9A, 9B, 10A through 10C, 11A, and 11B, and the detailed explanation thereof will be omitted.

### A-5-1. First Variation

In the first variation, a configuration in which the input surface 310 of the input device 300 can be used as a magnifying glass for enlarging the virtual operation section will be explained.

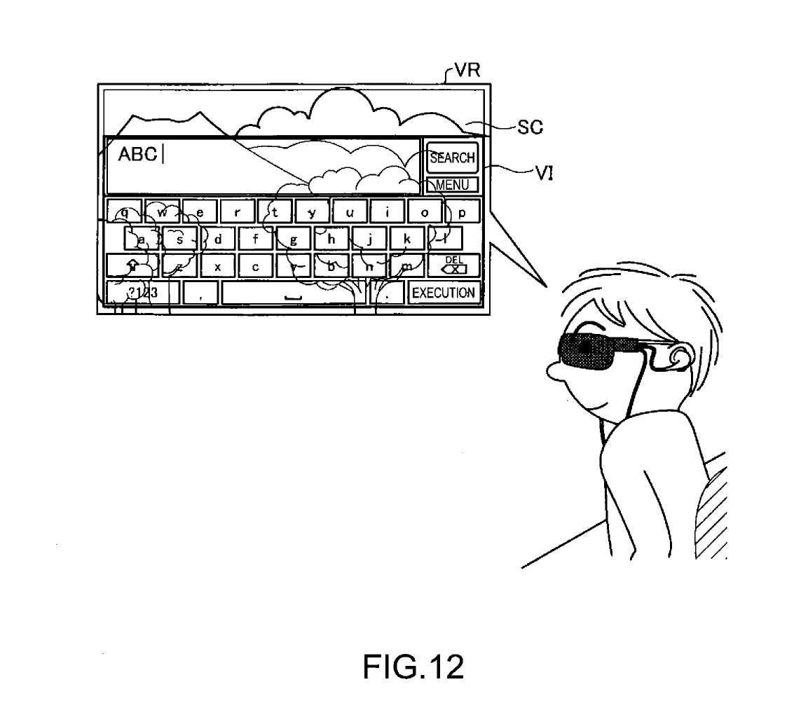

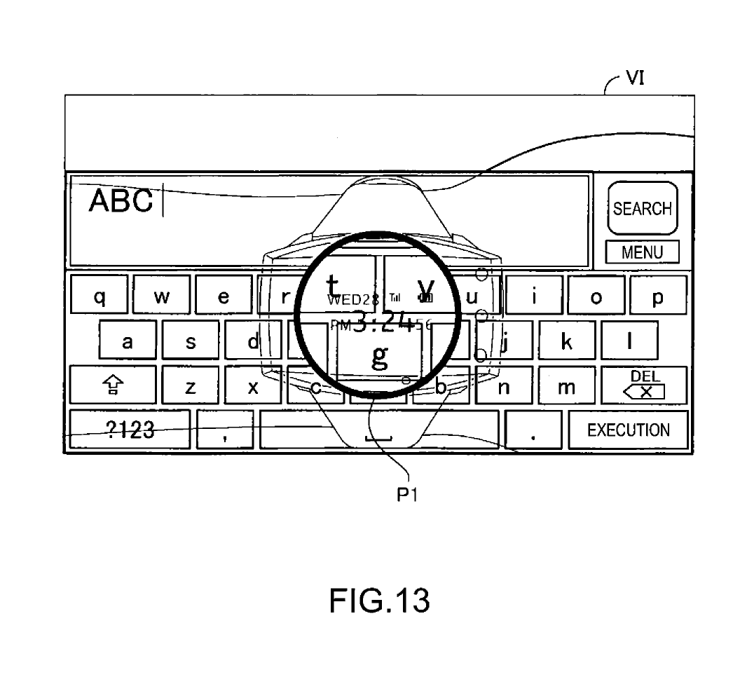

FIGS. 12 and 13 are explanatory diagrams for explaining the first variation of the input process. The first variation is different in points b1, b2 cited below compared to the arrangement process explained using FIGS. 5, 7, 8, 9A, 9B, 10A through 10C, 11A, and 11B.

(b1) The operation control section 142 does not adopt the “execution condition of the input process” explained with reference to FIG. 7, and displays the virtual image representing the virtual operation section when needed based on the operation of the user, a request from the OS 150, a request from other application programs, and so on. it should be noted that the execution condition of the input process explained with reference to FIG. 7 is that the virtual image of the virtual operation section can be superimposed on the input surface 310 (i.e., the eyes of the user wearing the head-mounted display 100 and the input surface 310 of the input device 300 are roughly collinear with each other). As a result, as shown in FIG. 12, even in the case in which the user does not look at the input surface 310, the virtual image VI of the virtual operation section VO is displayed in front of the eyes of the user.

(b2) In the case in which at least a part of the virtual image of the virtual operation section is superimposed on the input surface 310, the operation control section 142 makes the user visually recognize the virtual image of the virtual operation section in which the part superimposed is enlarged. Specifically, the operation control section 142 monitors the superimposition between the virtual image of the virtual operation section and the input surface 310 in parallel to the input process explained with reference to FIGS. 7 and 8. After detecting the superimposition, the operation control section 142 generates an image of the virtual operation section with the superimposed part enlarged, and then transmits the image thus generated to the image processing section 160. Subsequently, in the image processing section 160, the display process described above is performed based on the image thus received. As a result, as shown in FIG. 13, it is possible for the user of the head-mounted display 100 to visually recognize the virtual image VI of the virtual operation section VO in which a part P1 where the virtual image VI of the virtual operation section VO and the input surface 310 are superimposed on each other is enlarged. It should be noted that the determination of the part P1 of the superimposition can be performed using the infrared ray, or by performing the image recognition on the image in the visual line direction of the user shot by a camera 61 of the head-mounted display 100.

As described above, according to the first variation of the input process, in the case in which at least a part of the virtual image VI of the virtual operation section VO is superimposed on the input surface 310, the operation control section 142 makes the user visually recognize the virtual image VI of the virtual operation section VO in which the part superimposed is enlarged. Therefore, it becomes possible for the user to use the input surface 310 of the input device 300 as a magnifying glass of the virtual operation section VO.

### A-5-2. Second Variation

In the second variation, a configuration in which the virtual operation section can be operated using two fingers of the user will be explained.

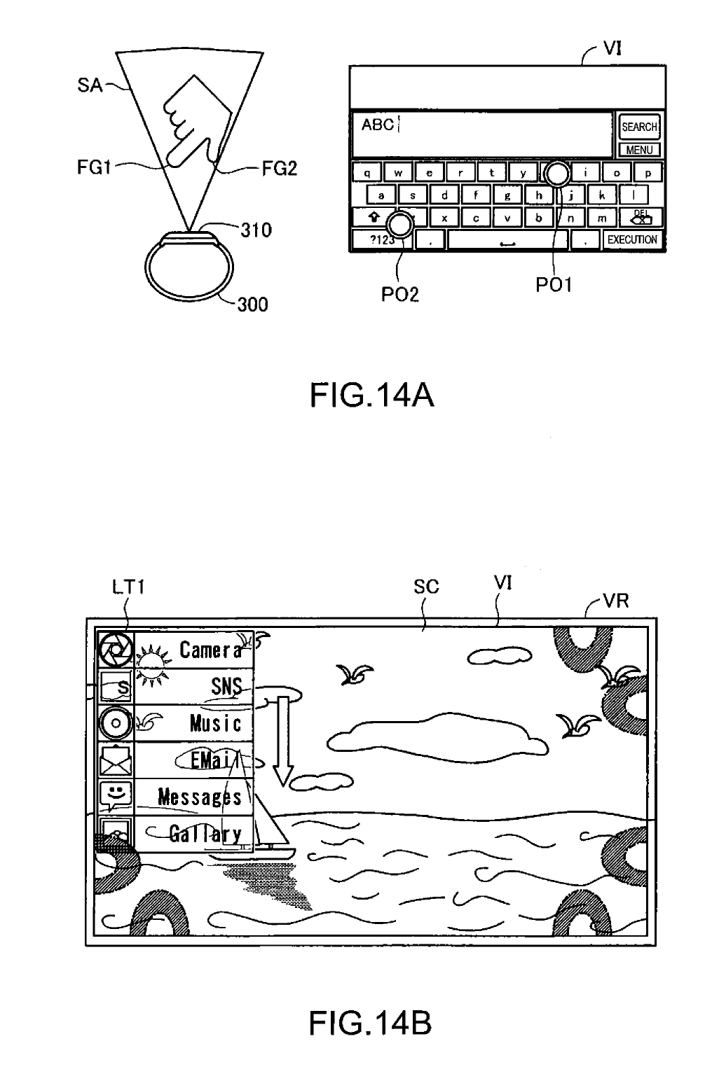

FIGS. 14A and 14B are explanatory diagrams for explaining the second variation of the input process. The second variation is different in points c1 through c3 cited below compared to the arrangement process explained using FIGS. 5, 7, 8, 9A, 9B, 10A through 10C, 11A, and 11B.

(c1) The motion detection section 320 of the input device 300 detects the motions of the two (or more) fingers FG1, FG2 (FIG. 14A), respectively.

(c2) In the step S102 of FIG. 7, the control section 351 determines whether or not the two (or more) fingers of the user are detected on the input surface 310. In the case in which the two or more fingers have been detected, the control section 351 makes the process make the transition to c3 described below, in the case in which the one finger has been detected, the control section 351 makes the process make the transition to the step S104 in FIG. 7, and in the case in which no finger of the user has been detected, the process returns to the step S102, and the determination on whether or not the finger has been detected is repeated.

(c3) In the step S106 in FIG. 7, the operation section 142 obtains the coordinates of the fingers FG1, FG2 of the user, respectively.

(c4) In the step S108 in FIG. 7, the operation control section 142 displays a pointer PO1 corresponding to the finger FG1 of the user and a pointer PO2 corresponding to the finger FG2 of the user in the virtual operation section VO.

In the second variation, the operations cited as d1 through d9 below becomes possible in addition to the click operation (tap operation), the long click operation (long tap operation), the flick operation, and the drag operation explained in the paragraph of the input process described above.

(d1) In accordance with an operation of sliding the two fingers, the operation control section 142 performs region selection of an image (e.g., a part of the virtual operation section VO, and a content image).

(d2) In accordance with an operation of sliding the two fingers, the operation control section 142 performs expansion and contraction of an image (e.g., a part of the virtual operation section VO, and a content image).

(d3) In accordance with an operation of rotating the two fingers, the operation control section 142 performs rotation of the image selected in d1 described above. Whether or not the “operation of rotating” the image is designated can be determined based on the amounts of the motions of one of the fingers and the other of the fingers, respectively. The rotational direction can be determined based on the variations of the coordinates of the two points of the respective fingers. It should be noted that in this case, it is also possible for the operation control section 142 to determine the rotational angle of the image in accordance with the rotational velocity of the fingers or the number of rotations of the fingers.

(d4) In accordance with a finger tip operation of pinching an image (e.g., the virtual operation section VO, and an image representing a window) with the two fingers, the operation control section 142 performs a drag movement of the image or a rotational movement including a three-dimensional depth of the image. It should be noted that the finger tip operation denotes an operation of pinching an end of the image as shown in FIG. 14B. It should be noted that in this case, it is also possible for the operation control section 142 to make the motion detection section 320 detect the level of the contact pressure of each of the fingers, and then determine the direction of the rotational movement in accordance with the level of the contact pressure thus detected.

(d5) In accordance with the finger tip operation of pinching an image (e.g., the virtual operation section VO, and an image representing a window) with the two fingers, the operation control section 142 performs a command (function) assigned in advance to the place at which the finger tip operation is performed. It should be noted that the assignment of the commands to the places can be implemented in, for example, the following manner.
The operation control section 142 makes the transition to a command input mode using the movement of the pointer to a vicinity of a frame of the virtual operation section as a trigger.
In the command input mode, the operation control section 142 temporarily displays a menu list LT1 shown in FIG. 14B.
The user selects a command to be assigned from the menu list LT1.

(d6) In accordance with an operation of touching the input surface 310 with the two fingers while rotating the two fingers, the operation control section 142 performs rotational expansion or rotational contraction of an image (e.g., a part of the virtual operation section VO, and a content image). Whether or not the “operation of rotating” the image is designated can be determined based on the amounts of the motions of one of the fingers and the other of the fingers, respectively.

(d7) In accordance with an operation of touching an upper frame line and a lower frame line, or a right frame line and a left frame line of the frame of the virtual operation section with respective fingers while rotating the two fingers, the operation control section 142 performs rotational expansion or rotational contraction of an image (e.g., a part of the virtual operation section VO, and a content image).

(d8) In d6 or d7 described above, the operation control section 142 determines which one of rotational expansion and rotational contraction is designated using at least either one of the rotational direction, the coordinate variation of the distance between the two fingers, and the rotation amount. The rotational direction can be determined based on the variations of the coordinates of the two points of the respective fingers.

(d9) In d6 or d7 described above, the operation control section 142 determines the rotation amount and the magnification ratio of expansion/contraction using at least either one of the rotational velocity, the number of rotations, and the contact angle with the frame line.

### A-5-3. Third Variation

In the third variation, a configuration for making it possible to easily determine the position of the input surface 310 of the input device 300 in the virtual operation section will be explained.

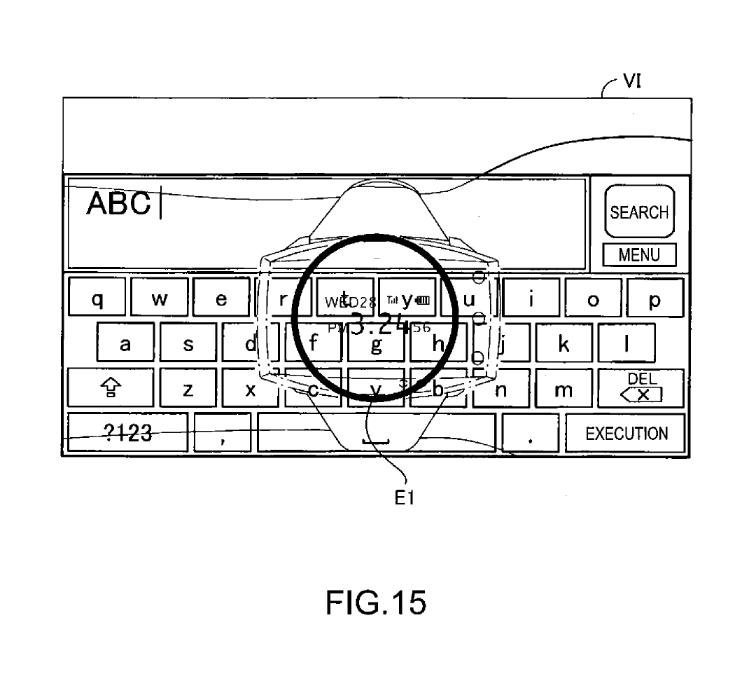

FIG. 15 is an explanatory diagram for explaining the third variation of the input process. The third variation is different in a point e1 cited below compared to the arrangement process explained using FIGS. 5, 7, 8, 9A, 9B, 10A through 10C, 11A, and 11B.

(e1) In the step S108 in FIG. 7, the operation control section 142 displays an image (hereinafter also referred to as an “input screen image”) representing the position of the input surface 310 of the input device 300 together with the pointer in the virtual operation section. Specifically, the operation control section 142 superimposes both of the image representing the pointer and the input screen image on the position of the coordinate of the finger obtained in the step S106 in FIG. 7, and then transmits the image thus superimposed to the image processing section 160. Subsequently, in the image processing section 160, the display process described above is performed based on the image thus received. As a result, as shown in FIG. 15, it is possible for the user of the head-mounted display 100 to visually recognize the virtual image VI of the virtual operation section VO including an input screen image EI representing the input surface 310. It should be noted that as the input screen image, there can be adopted an image having an arbitrary form such as a rectangular image besides the ring-like image shown in FIG. 15. Further, the determination of the position of the input surface 310 can be performed using the infrared ray, or by performing the image recognition on the image in the visual line direction of the user shot by the camera 61 of the head-mounted display 100.

In the third variation, by operating the input screen image with the finger of the user, it is possible for the operation control section 142 to perform the operations such as rotation, copy, expansion, contraction, and page feed of the image (i.e., the virtual operation section VO, an image representing a window).

### B. Modified Examples

In the embodiment described above, it is possible to replace a part of the configuration assumed to be implemented by hardware with software, or to replace a part of the configuration assumed to be implemented by software with hardware. Besides the above, the following modifications are also possible.

### First Modified Example

In the above description of the embodiment, the configuration of the image display system is described as an example. However, the configuration of the image display system can arbitrarily be determined within the scope or the spirit of the invention, and addition, elimination, replacement, and so on of each of the devices constituting the image display system can be performed. Further, a modification of the network configuration of the devices constituting the image display system can be performed.

For example, a plurality of input devices can also be connected to the head-mounted display. Further, the input device can also be configured so as to be able to be used as an input device for a plurality of head-mounted displays. In such cases, the head-mounted displays each store identification information for identifying the input device to be the counterpart of the connection. Similarly, the input devices each store identification information for identifying the head-mounted display to be the counterpart of the connection. According to this configuration, it becomes possible to make one input device be shared in a plurality of head-mounted displays, or to make one head-mounted display be shared in a plurality of input devices, convenience for the user can be enhanced.

For example, a part of the functions of the operation control section of the head-mounted display according to the embodiment can also be provided by the control section of the input device. Similarly, a part of the functions of the control section of the input device according to the embodiment can also be provided by the operation control section of the head-mounted display.

For example, the input device and the head-mounted display can communicate with each other using a variety of communication methods (wireless communication/wired communication) besides the communication method explained in the above description of the embodiment as an example.

### Second Modified Example

In the above description of the embodiment, the configuration of the input device is described as an example. However, the configuration of the input device can arbitrarily be determined within the scope or the spirit of the invention, and addition, elimination, replacement, and so on of each of the constituents can be performed.

For example, the input device can also be configured in other forms than the watch type. The input device can also be configured in a variety of forms such as a remote controller type, a bracelet type, a ring type, a broach type, a pendant type, an ID card type, or a key chain type.

For example, it is possible to adopt a configuration in which the input device is provided with a nine-axis sensor (motion sensor) capable of detecting the accelerations (3 axes), angular velocities (3 axes), and geomagnetisms (3 axes), and the control section can also correct the motion of the finger of the user obtained by the motion detection section using the detection values of the nine-axis sensor.

For example, it is also possible to adopt a configuration in which the input device is provided with a plurality of input surfaces to make it possible to perform the operation in the virtual operation section having the motion of the finger of the user obtained by the motion detection section and the touch operations to the plurality of input surfaces combined with each other. Further, it is also possible for the input device to obtain a configuration, which activates a part of the plurality of input surfaces and sets the rest of the plurality of input surfaces to a standby state, from the user.

For example, it is also possible to adopt a configuration in which the input device is provided with a camera, and it is possible to adopt a configuration in which the function of the camera can be used using the virtual operation section.

For example, the motion detection section can also include four or more infrared LEDs or three or more cameras. In this case, it is possible for the operation control section to divide the virtual operation section into a plurality of regions, and individually control (i.e., provide a directive property to the virtual operation section) the regions.

### Third Modified Example

In the above description of the embodiment, the configuration of the head-mounted display is described as an example. However, the configuration of the head-mounted display can arbitrarily be determined within the scope or the spirit of the invention, and addition, elimination, replacement, and so on of each of the constituents can be performed.

The assignment of the constituents to the control section and the image display section in the embodiment described above is illustrative only, and a variety of configurations can be adopted. For example, the following configurations can also be adopted.

(i) Processing function such as a CPU and a memory is installed in the control section, and only a display function is installed in the image display section.

(ii) The processing function such as the CPU and the memory is installed in both of the control section and the image display section.

(iii) The control section and the image display section are integrated with each other (e.g., the image display section includes the control section to function as a glasses-type wearable computer).

(iv) A smartphone or a portable gaming machine is used instead of the control section.

(v) A configuration capable of communicating wirelessly and supplying power wirelessly is provided to the control section and the image display section to thereby eliminate the connection section (cords).

(vi) The touch pad is eliminated from the control section, and the touch pad is provided to the image display section.

In the embodiment described above, it is assumed that the control section is provided with the transmitting sections, and the image display section is provided with the receiving sections for the sake of convenience of explanation. However, each of the transmitting sections and the receiving sections of the embodiment described above is provided with a function capable of bidirectional communication, and can function as a transmitting and receiving section. Further, it is also possible for the control section and the image display section to be connected to each other with the connection via wireless signal transmission path such as a wireless LAN, infrared communication, or Bluetooth.

For example, the configurations of the control section and the image display section can arbitrarily be modified. Specifically, for example, the control section can also be provided with a variety of input devices (e.g., an operating stick, a keyboard, and a mouse) besides the various types of input devices (the touch pad, the arrow keys, the foot switch, the gesture detection, the visual line detection, and the microphone) described above. Further, although in the embodiment described above it is assumed that the secondary battery is used as the power supply, the power supply is not limited to the secondary battery, but a variety of batteries can be used as the power supply. For example, a primary battery, a fuel battery, a solar cell, a thermal battery, and so on can also be used.

For example, although it is assumed that the head-mounted display is a binocular type transmissive head-mounted display, a monocular type head-mounted display can also be adopted. Further, it is also possible to adopt a configuration as a non-transmissive head-mounted display in which the transmission of the external sight is blocked in the state in which the user wears the head-mounted display. Although in the present embodiment described above, there is assumed the head-mounted display having the image display section worn like a pair of glasses, it is also possible to adopt a head-mounted display in which the image display section having any other shape such as an image display section of a type worn like a hat or a cap is adopted. Further, as the earphones, an ear hook type or a headband type can be adopted, or the earphones can be eliminated. Further, it is also possible to adopt a configuration as the head-up display (HUD) to be installed in a mobile object such as a vehicle or a plane. Besides the above, it is also possible to adopt a configuration as the head-mounted display incorporated in a body protector such as a helmet.

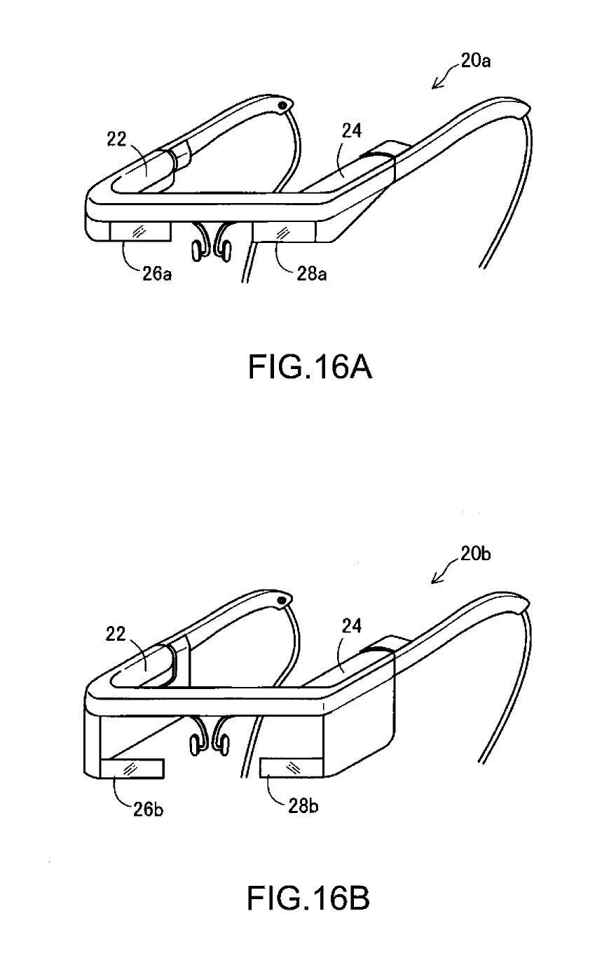

FIGS. 16A and 16B are explanatory diagrams each showing a configuration of an appearance of a head-mounted display according to a modified example. In the example shown in FIG. 16A, an image display section 20a is provided with a right optical image display section 26a instead of the right optical image display section 26, and is provided with a left optical image display section 28a instead of the left optical image display section 28. The right optical image display section 26a and the left optical image display section 28a are formed to be smaller than the optical members of the embodiment, and are disposed obliquely above the right eye and the left eye of the user, respectively, when wearing the head-mounted display. In the example shown in FIG. 16B, an image display section 20b is provided with a right optical image display section 26b instead of the right optical image display section 26, and is provided with a left optical image display section 28b instead of the left optical image display section 28. The right optical image display section 26b and the left optical image display section 28b are formed to be smaller than the optical members of the embodiment, and are disposed obliquely below the right eye and the left eye of the user, respectively, when wearing the head-mounted display. As described above, it is sufficient for each of the optical image display sections to be disposed in the vicinity of the eye of the user. Further, the size of the optical member forming each of the optical image display sections is arbitrarily determined, and it is possible to implement the head-mounted display having a configuration in which the optical image display sections each cover only a part of the eye of the user, in other words, the configuration in which the optical image display sections each do not completely cover the eye of the user.

For example, in the embodiment described above, it is assumed that the display drive section is configured using the backlight, the backlight control section, the LCD, the LCD control section, and the projection optical system. However, the configuration described above is illustrative only. It is also possible for the display drive section to be provided with a constituent for implementing another system together with or instead of these constituents. For example, it is also possible for the display drive section to have a configuration including an organic EL (organic electroluminescence) display, an organic EL control section, and a projection optical system. Further, for example, it is also possible for the display drive section to use a digital micromirror device or the like instead of the LCD. Further, for example, it is also possible to apply the invention to a laser retinal projection head-mount type display device.

For example, the functional sections such as the operation control section, the image processing section, the display control section, and the sound processing section are described assuming that these sections are implemented by the CPU developing the computer program, which is stored in the ROM or the hard disk, on the RAM, and then executing it. However, it is also possible for these functional sections to be configured using an application specific integrated circuit (ASIC) designed for implementing the functions.

For example, the operation control section can also display a virtual image representing a menu screen (a screen in which the functions are displayed as a list) of the head-mounted display in the case in which the operation control section performs image recognition on an image in the visual field direction of the user shot by the camera of the head-mounted display, and recognizes the fact that the input device is shown in the image.

### Fourth Modified Example

In the above description of the embodiment, an example of the input process is described. However, the procedure of the input process is illustrative only, and a variety of modifications can be made. For example, it is also possible to eliminate some steps or to add other additional steps. Further, the execution sequence of the steps can also be modified.

For example, in the step S112, it is also possible for the operation control section to adopt the fact that the input surface of the input device is tapped as the condition to be satisfied in the step S112 instead of the case in which the distance L1 obtained based on the motion of the finger of the user is equal to or smaller than the third threshold value. Further, it is also possible for the operation control section to adopt the fact that the detection values (i.e., the variations of the input device) of the nine-axis sensor exceed predetermined threshold values as the condition to be satisfied in the step S112 in the case in which the input device is provided with the nine-axis sensor.

For example, in the step S108, in the case in which the pointer is moved to the frame of the virtual operation section, the operation control section can also highlight the frame of the virtual operation section in addition to the display of the pointer. As highlighting, there can be adopted configurations such as increasing the thickness of the frame lines, changing the color of the frame, or blinking the frame.

For example, in the step S102, it is possible for the operation control section to adopt the conditions cited below as examples together with the condition (whether or not the finger of the user has been detected on the input surface) of the step S102 or instead of the condition of the step S102.
The vertical and horizontal directions of the input surface of the input device coincide with the vertical and horizontal directions of a virtual image to be displayed in the image display section, respectively. It should be noted that the term “coincide” can tolerate a predetermined error (e.g., within 15 degrees).
Touch to the input surface of the input device is detected.
An unlocking device is provided to the input device, and unlocking is detected. The unlocking device can be detection of a predetermined operation to the input surface, detection of holding-down of a predetermined button, and so on.

According to such a configuration, it is possible to further limit the condition for displaying the virtual operation section. Therefore, it is possible to inhibit the virtual operation screen from being displayed despite the intention of the user due to an erroneous operation or the like.

For example, in the step S104, it is also possible for the operation control section to notify the user of the fact that an operation input acceptance mode of the virtual operation section has been set. As this notification, there can be adopted a variety of methods such as a sound, a voice, a vibration, or display on the input surface of the input device. According to this configuration, since the user can be aware of the fact that the operation input acceptance mode of the virtual operation section has been set, convenience for the user is enhanced.

For example, in addition to the input process according to the embodiment described above, the operation control section can also change the size of the virtual operation section to be displayed as a virtual image in accordance with a rough distance L2 between the head-mounted display and the input device. For example, it is also possible for the operation control section to decrease the size of the virtual operation section to be displayed as the distance L2 increases (the both devices move away from each other). Similarly, it is also possible for the operation control section to increase the size of the virtual operation section to be displayed as the distance L2 decreases (the both devices move closer to each other). It should be noted that the rough distance between the head-mounted display and the input device can be obtained using the infrared ray, or by performing the image recognition on the image in the visual line direction of the user shot by the camera of the head-mounted display.

For example, in addition to the input process according to the embodiment described above, the operation control section can also change the range or the form of the virtual operation section to be displayed as a virtual image in accordance with the rough distance L2 between the head-mounted display and the input device. In the case of changing the range, for example, the operation control section widens the range of the virtual operation section to be displayed so that the overview of the virtual operation section can be obtained as the distance L2 increases (the both devices move away from each other). Similarly, the operation control section narrows the range of the virtual operation section to be displayed so as to enlarge a part of the virtual operation section as the distance L2 decreases (the both devices move closer to each other).

### Fifth Modified Example

In the above description of the embodiment, an example of the virtual operation section is described. However, the configuration of the virtual operation section is illustrative only, and a variety of modification can be made.

For example, the operation control section can also display a portrait virtual operation section instead of the landscape virtual operation section shown in FIGS. 5, 9A, and 9B. Further, the operation control section can also display a three-dimensional virtual operation section instead of the two-dimensional virtual operation section shown in FIGS. 5, 9A, and 9B. In the case of displaying the three-dimensional virtual operation section, it is sufficient for the operation control section to supply the image display section with the right-eye image data and the left-eye image data different from each other. Further, the shape and the size of the virtual operation section displayed by the operation control section can arbitrarily be changed.

For example, it is also possible for the operation control section to display a virtual operation section having one of the input interfaces cited below, or a plurality of the input interfaces cited below arranged in combination, instead of the virtual operation section having the keyboard arranged shown in FIG. 9A or the virtual operation section having the desktop screen of the OS arranged shown in FIG. 9B.
arrow keys
click wheel (an input section for switching the input by circularly sliding the finger)
button disposed in the periphery of the click wheel
handwriting character input pad
operation buttons for an audio (video) system

### Sixth Modified Example

It should be noted that the invention is not limited to the embodiment, specific examples, and the modified examples described above, but can be implemented with a variety of configurations within the scope or the spirit of the invention. For example, the technical features in the embodiment, the practical examples, and the modified examples corresponding to the technical features in the aspects described in SUMMARY section can arbitrarily be replaced or combined in order to solve all or a part of the problems described above, or in order to achieve all or a part of the advantages described above. Further, the technical feature can arbitrarily be eliminated unless described in the specification as an essential element.

The entire disclosure of Japanese Patent Application No. 2013-229441, filed Nov. 5, 2013 is expressly incorporated by reference herein.

What is claimed is:

1. An image display system comprising:
a transmissive head-mount type display device; and
an input device adapted to operate the head-mount type display device,
wherein the input device includes a motion detection section adapted to detect a motion of at least one finger of a user, and
the head-mount type display device includes an operation control section adapted to make the user visually recognize a virtual operation section as a virtual image, the virtual operation section being used for operating the head-mount type display device, and corresponding to the motion of the finger detected.

2. The image display system according to claim 1, wherein
the input device further includes an input surface adapted to detect information of a position touched by the user, and
the operation control section makes the user visually recognize the virtual image of the virtual operation section larger than the input surface.

3. The image display system according to claim 2, wherein
the operation control section makes the user visually recognize the virtual image of the virtual operation section only in a case in which at least a part of the virtual image of the virtual operation section can be superimposed on the input surface.

4. The image display system according to claim 2, wherein
in a case in which at least a part of the virtual image of the virtual operation section is superimposed on the input surface, the operation control section makes the user visually recognize the virtual image of the virtual operation section in which the part superimposed is enlarged.

5. The image display system according to claim 2, wherein
the motion detection section detects a distance between the input surface and the finger of the user as a part of the motion of the finger, and
the operation control section makes the user visually recognize the virtual image of the virtual operation section using a fact that the distance detected becomes one of equal to and smaller than a first threshold value as a trigger.

6. The image display system according to claim 1, wherein
the head-mount type display device further includes an image display section adapted to form the virtual image, and
the operation control section
converts the motion of the finger detected into coordinate variation of a pointer on the virtual operation section to thereby generate a virtual operation section corresponding to the motion of the finger detected, and
makes the image display section form a virtual image representing the virtual operation section generated.

7. The image display system according to claim 6, wherein
the motion detection section detects a distance between the input surface and the finger of the user as a part of the motion of the finger, and
the operation control section
stops the conversion using a fact that the distance detected becomes one of equal to and smaller than a second threshold value as a trigger, and
sets a coordinate of the pointer on which the conversion is performed last time to an input to the head-mount type display device using a fact that the distance detected becomes one of equal to and smaller than a third threshold value smaller than the second threshold value as a trigger.

8. The image display system according to claim 1, wherein
the input device is configured as a wearable device, which can be worn by the user.

9. A method of controlling an image display system including a transmissive head-mount type display device, and an input device adapted to operate the head-mount type display device, the method comprising:
detecting, by the input device, a motion of a finger of a user; and
making, by the head-mount type display device, the user visually recognize a virtual operation section as a virtual image, the virtual operation section being used for operating the head-mount type display device, and corresponding to the motion of the finger detected.

10. A head-mount type display device comprising:
an operation control section adapted to generate a virtual operation section used for operating the head-mount type display device, and corresponding to a motion of at least one finger of a user; and
an image display section adapted to form a virtual image representing the virtual operation section generated.
